(19) United States
(12) Patent Application Publication
(10) Pub. No.: US 2022/0405438 A1
(43) Pub. Date: Dec. 22, 2022

(54) Optimizing the Shape of an Object to Facilitate Wrinkle and Stress Reduction

(71) Applicant: The Boeing Company, Chicago, IL (US)

(72) Inventors: Troy Winfree, Seattle, WA (US); Eric S. Kamila, Edmonds, WA (US); Noah J. Stockwell, West Lafayette, IN (US); William J. Moon, Bothell, WA (US); Jerry D. Chungbin, Kenmore, WA (US)

(21) Appl. No.: 17/720,961

(22) Filed: Apr. 14, 2022

Related U.S. Application Data
(60) Provisional application No. 63/211,785, filed on Jun. 17, 2021.

(51) Int. Cl. G06F 30/20; G06F 30/10; G05B 13/04

(52) U.S. Cl. CPC G06F 30/20; G06F 30/10; G05B 13/042

(57) ABSTRACT

A method implemented by a computing system that facilitates formation of an object from a material comprises receiving an object model that specifies a top surface and a side surface connected to an edge of the top surface via a fillet that extends along the edge. At a particular region along the edge, adjacent planar regions of the side surface define an obtuse angle therebetween. The fillet is adjusted along the edge to have a first radius at a particular distance from the particular region and to have a second radius, smaller than the first radius, proximate the particular region. Output data associated with an adjusted model is communicated to equipment configured to form a mandrel that facilitates formation of the object. Adjusting the fillet to have a smaller radius proximate the particular region facilitates elimination of wrinkles in the material when draped over the mandrel to form the object.

### RELATED APPLICATIONS

This application claims the benefit of priority under 35 U.S.C. § 119(e) of U.S. Provisional Application No. 63/211,785, filed Jun. 17, 2021, the content of which is incorporated herein by reference in its entirety.

### BACKGROUND

### Field

This application generally relates to manufacturing processes. In particular, this application describes a method and system for optimizing the shape of an object to remove material tension and compression during manufacture. This reduces associated defect outcomes including material wrinkling and bridging.

### Description of Related Art

Drape forming is a manufacturing technique in which a sheet or sheets of material, such as plastic or resin-infused composite, is placed on a single positive mold or mandrel to form an object having the shape of the mandrel. In some applications, thermal processing softens the material. The material may conform to the shape under its own weight or pressure may be applied to facilitate conforming the material to the shape.

In some instances, the shape of the mandrel includes features that make it difficult for the material to uniformly conform to the shape of the mandrel. For example, the mandrel may include regions of large double curvature or regions with sharp corners. When draping the material over these regions, the material may wrinkle or become stressed. Wrinkles reduce the strength of the final product, and over-stressed portions may tear during object formation or result in material thinning which also reduces final product strength.

### SUMMARY

In a first aspect, a method performed by a computing system that facilitates formation of an object comprises receiving manufacturing process data associated with an object to be formed via a drape-forming operation. The computing system receives a parametric model of the object. The parametric model facilitates specification of a radius of a fillet within a region associated with the object. The computing system determines, based on the parametric model of the object, a unit vector field on the object. The computing system adjusts the radius of the fillet of the parametric model within the region to reduce an average divergence of the unit vector field to a minimum amount, and communicates output data associated with an adjusted parametric model to equipment configured to form a mandrel that facilitates formation of the object.

In a second aspect, a system comprises a memory that stores instruction code, and one or more processors in communication with the memory. The instruction code is executable by the one or more processors to perform operations comprising receiving manufacturing process data associated with an object to be formed via a drape-forming operation. The one or more processors receive a parametric model of the object. The parametric model facilitates specification of a radius of a fillet within a region associated with the object. The one or more processors determine, based on the parametric model of the object, a unit vector field associated with the object. The one or more processors adjust the radius of the fillet of the parametric model within the region to reduce an average divergence of the unit vector field to a minimum amount, and communicate output data associated with an adjusted parametric model to equipment configured to form a mandrel that facilitates formation of the object.

In a third aspect, a non-transitory computer-readable medium includes instruction code. The instruction code is executable by one or more processors for causing the one or more processors to perform operations comprising receiving manufacturing process data associated with an object to be formed via a drape-forming operation. The one or more processors receive a parametric model of the object. The parametric model facilitates specification of a radius of a fillet within a region associated with the object. The one or more processors determine, based on the parametric model of the object, a unit vector field associated with a surface of the object. The one or more processors adjust the radius of the fillet of the parametric model within the region to reduce an average divergence of the unit vector field to a minimum amount, and communicate output data associated with an adjusted parametric model to equipment configured to form a mandrel that facilitates formation of the object.

In a fourth aspect, a method implemented by a computing system that facilitates formation of an object from a material comprises receiving, by the computing system, an object model associated with the object. The object model specifies at least a top surface and a side surface connected to an edge of the top surface via a fillet that extends along the edge. At a particular region along the edge, adjacent planar regions of the side surface define an obtuse angle therebetween. Within a parametric model associated with the object model, the fillet is adjusted along the edge to have a first radius at a particular distance from the particular region and to have a second radius, which is smaller than the first radius, proximate the particular region along the edge. The computing system communicates output data associated with an adjusted parametric model to equipment configured to form a mandrel that facilitates formation of the object, wherein adjusting the fillet to have a smaller radius proximate the particular region along the edge facilitates elimination of wrinkles in the material when draped over the mandrel to form the object.

In a fifth aspect, a system comprises a memory that stores instruction code, and one or more processors in communication with the memory. The instruction code is executable by the one or more processors to perform operations comprising receiving, by the computing system, an object model associated with the object. The object model specifies at least a top surface and a side surface connected to an edge of the top surface via a fillet that extends along the edge. At a particular region along the edge, adjacent planar regions of the side surface define an obtuse angle therebetween. Within a parametric model associated with the object model, the fillet is adjusted along the edge to have a first radius at a particular distance from the particular region and to have a second radius, which is smaller than the first radius, proximate the particular region along the edge. The computing system communicates output data associated with an adjusted parametric model to equipment configured to form a mandrel that facilitates formation of the object, wherein adjusting the fillet to have a smaller radius proximate the particular region along the edge facilitates elimination of wrinkles in the material when draped over the mandrel to form the object.

In a sixth aspect, a non-transitory computer-readable medium includes instruction code. The instruction code is executable by one or more processors for causing the one or more processors to perform operations comprising receiving, by the computing system, an object model associated with the object. The object model specifies at least a top surface and a side surface connected to an edge of the top surface via a fillet that extends along the edge. At a particular region along the edge, adjacent planar regions of the side surface define an obtuse angle therebetween. Within a parametric model associated with the object model, the fillet is adjusted along the edge to have a first radius at a particular distance from the particular region and to have a second radius, which is smaller than the first radius, proximate the particular region along the edge. The computing system communicates output data associated with an adjusted parametric model to equipment configured to form a mandrel that facilitates formation of the object, wherein adjusting the fillet to have a smaller radius proximate the particular region along the edge facilitates elimination of wrinkles in the material when draped over the mandrel to form the object.

In another aspect, a method implemented by a computing system that facilitates formation of an object from a material comprises receiving, by the computing system, an object model associated with the object. The object model specifies at least a top surface and a side surface connected to an edge of the top surface via a fillet that extends along the edge. At a particular region along the edge, adjacent planar regions of the side surface define an obtuse angle therebetween. The method further comprises generating a parametric model that specifies the fillet in terms of a plurality of connected diamond-shaped patterns. Each diamond-shaped pattern is associated with a radius at a particular section of the fillet and comprises a pair of top-surface triangles that share an edge and a pair of side surface triangles that share an edge. The parametric model facilitates mapping a first draping direction in a first top-surface triangle to a first side surface triangle along a first geodesic and a second draping direction in a second top surface triangle to a second side surface triangle along a second geodesic. The method further comprises adjusting, by the computing system, radii associated with one or more of the plurality of connected diamond-shaped patterns to reduce an average angle deviation between the first geodesic and the second geodesic in the pair of side surface triangles across all diamond-shaped patterns to a minimum amount. The computing system communicates output data associated with an adjusted parametric model to equipment configured to form a mandrel that facilitates formation of the object. Adjusting the radii associated with one or more of the plurality of connected diamond-shaped patterns facilitates the elimination of wrinkles in the material when draped over the mandrel to form the object.

### BRIEF DESCRIPTION OF THE DRAWINGS

The accompanying drawings are included to provide a further understanding of the claims, are incorporated in, and constitute a part of this specification. The detailed description and illustrated examples described serve to explain the principles defined by the claims.

FIG. 1 illustrates an environment that includes various entities that cooperate to optimize the shape of an object to facilitate manufacturing the object, in accordance with an example.

FIG. 2A illustrates an object having a shape that can be optimized by a shape optimization system (SOS) of the environment, in accordance with an example.

FIG. 2B illustrates geodesic curves aligned with drape directions on the object, in accordance with an example.

FIG. 3 is a logical representation of object optimization logic (OOL) of the SOS, in accordance with an example.

FIG. 4A illustrates a unit vector field generated by the OOL, in accordance with an example.

FIG. 4B illustrates geodesic curves aligned with drape directions on the object after shape optimization, in accordance with an example.

FIG. 5 illustrates operations performed by the SOS that facilitate optimizing the shape of an object, in accordance with an example.

FIG. 6A illustrates a computer-implemented method performed by a computing system such as the SOS, in accordance with an example.

FIG. 6B illustrates further aspects of the computer-implemented method, in accordance with an example.

FIG. 6C illustrates yet further aspects of the computer-implemented method, in accordance with an example.

FIG. 7A illustrates a geometry for representing a fillet of an object, in accordance with an example.

FIG. 7B illustrates details of the geometry, in accordance with an example.

FIG. 7C illustrates a manifold model based on the geometry, in accordance with an example.

FIG. 7D illustrates a circle arc cross-section of the geometry, in accordance with an example.

FIG. 7E illustrates a mapping operation performed on the geometry, in accordance with an example.

FIG. 7F illustrates a further representation of the geometry, in accordance with an example.

FIG. 8 is a logical representation of an OOL that optimizes the shape of an object according to a methodology elucidated by the figures above, in accordance with an example.

FIG. 9 illustrates operations performed by the OOL, in accordance with an example.

FIG. 10 illustrates further operations performed by the OOL, in accordance with an example.

FIG. 11A illustrates further operations performed by the OOL, in accordance with an example.

FIG. 11B illustrates further operations performed by the OOL, in accordance with an example.

FIG. 12 illustrates further operations performed by the OOL, in accordance with an example.

FIG. 13 illustrates a computer system that can form part of or implement any of the systems or devices of the environment, in accordance with an example.

### DETAILED DESCRIPTION

Various examples of systems, devices, and/or methods are described herein. Words such as “example” and “exemplary” that may be used herein are understood to mean “serving as an example, instance, or illustration.” Any embodiment, implementation, and/or feature described herein as being an “example” or “exemplary” is not necessarily to be construed as preferred or advantageous over any other embodiment, implementation, and/or feature unless stated as such. Thus, other embodiments, implementations, and/or features may be utilized, and other changes may be made without departing from the scope of the subject matter presented herein.

Accordingly, the examples described herein are not meant to be limiting. It will be readily understood that the aspects of the present disclosure, as generally described herein, and illustrated in the figures, can be arranged, substituted, combined, separated, and designed in a wide variety of different configurations.

Further, unless the context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Moreover, terms such as “substantially” or “about” that may be used herein, mean that the recited characteristic, parameter, or value need not be achieved exactly, but that deviations or variations, including, for example, tolerances, measurement error, measurement accuracy limitations and other factors known to one skilled in the art, may occur in amounts that do not preclude the effect the characteristic was intended to provide.

### I. Introduction

As noted above, in drape manufacturing, the shape of an object can include features that make it difficult for the material to uniformly conform to the shape of the mandrel for forming the object. For example, a region or regions of the object may define large double curvatures, or sharp corners. When draping the material over these regions, the material can tend to wrinkle, which can cause manufacturing or part strength issues.

Disclosed herein are examples of a shape optimization system (SOS) that optimizes the shape of the object to reduce or eliminate these issues. Generally, the SOS is configured to receive data that defines the shape of an object to be formed via a drape-forming operation. The SOS receives and operates on a parametric model of the object that facilitates specification of the radius of a fillet within, for example, a fillet surface (e.g., a circle-arc cross-section surface that joins two other surfaces with a continuous blend) of the object. The fillet may include abrupt changes in direction as it follows the adjacent shape of the object. In an example, the SOS adjusts the radius of the fillet in the parametric model within the fillet surface to reduce the average divergence of a unit vector field associated with the surface of the object and the forming process. More generally, the SOS adjusts the radius of the fillet in the parametric model within the fillet surface to reduce a quantification of the convergence and divergence of geodesics in a composite material drape-forming model that represent fibers of the material. In this regard, a geodesic on a three-dimensional surface is equivalent to a straight line between two points in a plane. The geodesic represents the path of least energy that connects the two points. The ratio of the distance between neighboring geodesics within various surfaces of an object gives a simple geometric measure or quantification of the strain or geodesic strain in the material perpendicular to the geodesics.

After adjustment of the radius, the SOS communicates output data associated with the adjusted parametric model to equipment configured to form a mandrel that facilitates formation of the object.

Various examples of composite material drape-forming models/geodesic strain quantification pairs that facilitate adjustment of the radius are disclosed herein. These model/geodesic strain quantification pairs include a unit vector field-based model/mathematical divergence quantification pair (e.g., based on parameterized triangulated part geometry), and a unit vector field-based model/geodesic angle alignment quantification pair (e.g., based on parameterized chain-of-diamonds fillet geometry).

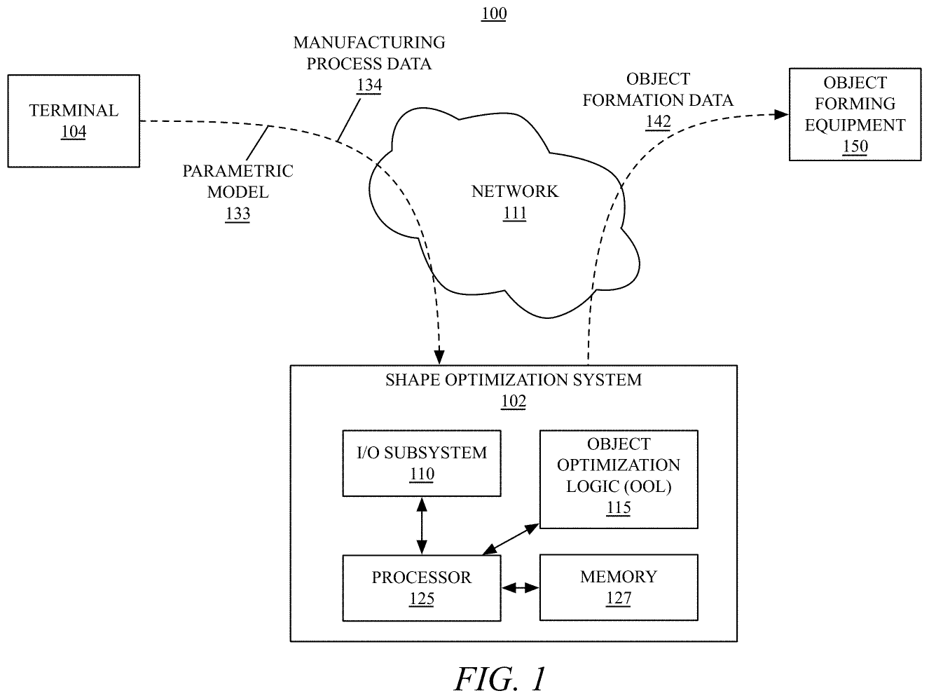

FIG. 1 illustrates an example of an environment 100 that includes various entities that cooperate to optimize the shape of an object to facilitate manufacturing the object. Example entities of the environment 100 include a shape optimization system (SOS) 102, a terminal 104, and object forming equipment 150. Examples of the various entities of the environment 100 are configured to communicate with one another via a network 111, such as the Internet.

Referring to the figure, an example of the terminal 104 corresponds to a computer system such as a desktop computer, tablet, etc. The terminal 104 can correspond to a different type of computing device. An example of the terminal 104 corresponds to a computer-aided design (CAD) workstation that facilitates the design of various articles. In this regard, an example of the terminal 104 executes software such as AutoCad®, TurboCad®, Sketchup®, etc., that facilitates 2D and 3D design. An example of the terminal 104 includes a graphics accelerator, co-processor, and/or other hardware that facilitates the design of the article.

An example of the terminal 104 executes a browser or other interface that facilitates communicating a parametric model 133 associated with a design to the SOS 102. An example of the parametric model 133 specifies the shape of an object. In an example, the parametric model 133 and/or the shape of the object is generated by design software executing on the terminal 104. For instance, an example of the parametric model 133 and/or the shape of the object is specified via a computer-aided design (CAD) program, such as AutoCad®, TurboCad®, Sketchup®, etc. Data that defines the parametric model 133 and/or the shape of the object may be specified in a file having a format such as a Drawing Exchange Format (DXF) or another file format.

An example of the parametric model 133 represents the design via constructive solid geometry (CSG). In CSG, the design is defined in terms of various primitive shapes, such as cylinders, cones, prisms, rectangles, spheres, etc. The parametric model 133 represents the design by combining one or more of these shapes according to various Boolean operations.

Another example of the parametric model 133 represents the design via boundary representation (BR). In BR, the design is defined in terms of the various geometric entities that form the object's spatial boundaries (e.g., points, edges, etc.) The design is then represented by joining these geometric entities.

Some CAD systems utilize mathematical entities such as splines to represent a design. Accordingly, some examples of the parametric model 133 represent the design via spline surface patches with a parametrically controlled variable radius fillet. Other examples of the parametric model 133 represent the design via triangulation with parametrically controlled fillet radius discretizations. Particular examples of a parametric model 133 described in further detail below represent the fillet of a design via a geometry that defines a chain or sequence of connected diamond-shaped patterns. These model types can be coupled with the various geodesic strain quantification methodologies disclosed herein.

An example of the object forming equipment 150 corresponds to a computer-numerical-control (CNC) milling machine. In this regard, an example of the object forming equipment 150 is configured to receive object forming data 142 that specifies an object to be formed. An example of the object forming data 142 is specified in a file having a format such as Drawing Exchange Format (DXF) or another file format that facilitates 3-dimensional representation of an object. In an example, the object forming equipment 150 is stationed at a remote location such as a factory.

In an example, the object forming equipment 150 is configured to form a mandrel. The mandrel is used in subsequent manufacturing operations, such as a drape forming process, to form an end-product or object having a shape that conforms and/or matches the shape of the mandrel.

The SOS 102 includes a memory 127, a processor 125, an input/output (I/O) subsystem 110, and object optimization logic (OOL) 115. Examples of the SOS 102 include other subsystems. As will be described in further detail below, the memory 127 stores instruction code that is executable by the processor 125 for causing the processor 125 to perform various operations.

As noted above, the processor 125 is in communication with the memory 127. The processor 125 is configured to execute instruction code stored in the memory 127. The instruction code facilitates performing, by the SOS 102, various operations that facilitate optimization of the design associated with the parametric model 133 communicated from the terminal 104. In this regard, the instruction code can cause the processor 125 to control and coordinate various activities performed by the different subsystems of the SOS 102. An example of the processor 125 corresponds to a stand-alone computer system such as an Intel®, AMD®, or ARM® based computer system or a different computer system and can include application-specific computer systems. An example of the computer system includes an operating system, such as Microsoft Windows®, Linux, Unix®, Mac OS®, or a different operating system.

An example of the I/O subsystem 110 includes one or more input, output, or input/output interfaces and is configured to facilitate communications with entities outside of the SOS 102, such as the terminal 104. In this regard, an example of the I/O subsystem 110 is configured to dynamically determine the communication methodology utilized by entities of the environment 100 and to communicate information to the entities with an interface that uses a determined communication methodology. For example, the I/O subsystem 110 can determine that a first entity utilizes a RESTful API and can, therefore, communicate with the entity using an interface that uses a RESTful communication methodology.

An example of the OOL 115 corresponds to hardware, software, or a combination thereof that is specifically configured to implement or assist in the implementation of various techniques or algorithms that facilitate optimization of the design of an object. For instance, an example of the OOL 115 implements a parametric modeler that facilitates adjusting parameters associated with a parametric model 133 that represents an object as a function of one or more variables or aspects associated with the object. An example of the OOL 115 implements algorithms for representing a vector field on an object and for determining the divergence of the vectors of the vector field. More generally, the OOL 115 adjusts the radius of the fillet in the parametric model within the fillet surface to reduce a quantification of the convergence and divergence of fibers in a composite material drape-forming model, which represents an amount of geodesic strain. Examples of the OOL 115 can implement other logic or techniques.

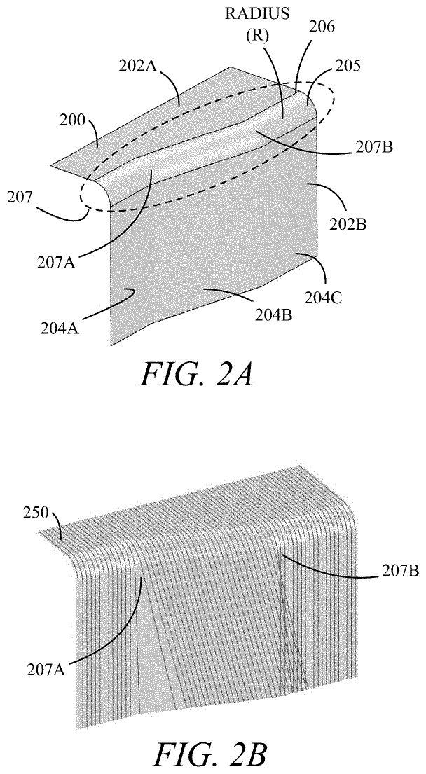

FIG. 2A illustrates an example of an object 200 defined by the parametric model 133. FIG. 2B illustrates geodesic curves 250 aligned with drape directions on the object 200. An example of the model specifies the object 200 to have a top surface 202A and a side surface 202B connected to an edge 206 of the top surface 202A via a fillet 205 that extends along the edge 206. For instance, an example of the object 200 has an L-shape cross-section and further defines a fillet 205 having a radius, R. In an example, adjacent planar regions (204A, 204B, 204C) of the side surface 202B define a ramp that starts at a first region 207A along the edge 206 and ends at a second region 207B along the edge 206. For instance, at the first region 207A, a first pair of adjacent planar regions (204A, 204B) define an obtuse angle (i.e., an angle less than 180 degrees) therebetween. At the second region 207B, a second pair of adjacent planar regions (204B, 204C) define a reflexive angle (i.e., an angle greater than 180 degrees) therebetween.

As noted above, forming an object 200 having such a shape can present problems. For example, the material from which the object 200 is formed may become stretched at the first region 207A and may become wrinkled at the second region 207B. For instance, as shown by the geodesic curves 250 of the object 200 illustrated in FIG. 2B, the paths along the surface begin to diverge at the first region 207A indicating a lack of material at the start of the ramp. The lack of material can result in stretching below the first region 207A, which can lead to tearing or thinning of material in that region. The paths along the surface begin to converge at the second region 207B indicating an excess of material at the second region 207B. The excess of material can result in wrinkles forming below the second region 207B.

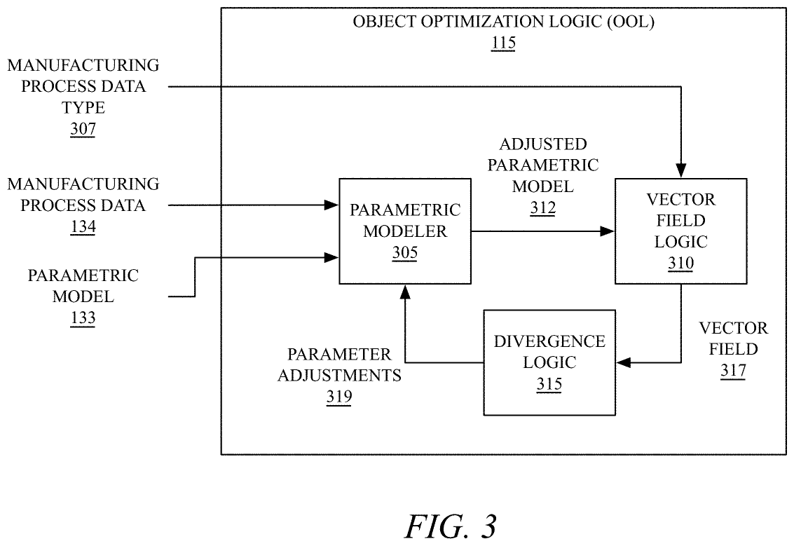

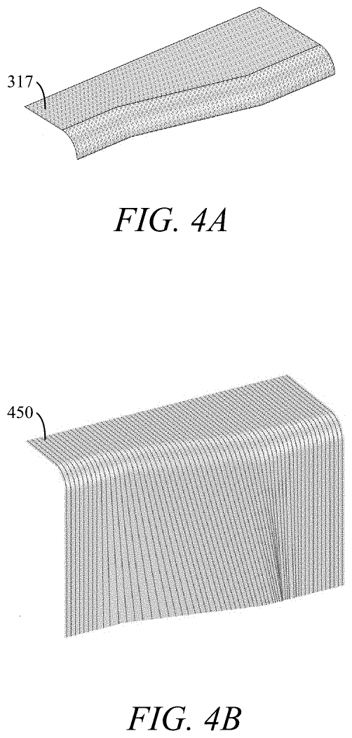

FIG. 3 is an example of a logical representation of the OOL 115. Referring to the figure, the OOL 115 includes a parametric modeler 305, vector field logic 310, and divergence logic 315. Operations performed by the OOL 115 are best understood with reference to the illustrations depicted in FIGS. 4A and 4B.

An example of the parametric modeler 305 is configured to receive a parametric model 133 that defines the shape of the object 200 to be formed and to generate an adjusted parametric model 312 of the object 200. An example of the parametric model 133 is specified in a file format such as a DXF file format or similar file format that facilitates specification of 3-dimensional objects and attributes associated with the object 200.

An example of the parametric model 133 represents the object 200 via constructive solid geometry (CSG). In CSG, the object 200 is defined in terms of various primitive shapes, such as cylinders, cones, prisms, rectangles, spheres, etc. The parametric model 133 represents the object 200 by combining one or more of these shapes according to various Boolean operations.

Another example of the parametric model 133 represents the object 200 via boundary representation (BR). In BR, the object 200 is defined in terms of the various geometric entities that form the object's spatial boundaries (e.g., points, edges, etc.) The object 200 is then represented by joining these geometric entities.

An example of the parametric modeler 305 facilitates the adjustment of one or more attributes associated with the parametric model 133. For instance, in an example, the parametric modeler 305 facilitates specification or adjustment of the radius of a fillet 205 of the object 200 within a particular region 207 of the object 200. In this regard, in an example, the radius of the fillet 205 is adjustable along the entire region 207, which facilitates forming a fillet having a non-uniform radius along the entire region 207. In another example, the parametric modeler 305 facilitates specification of other aspects such as the scale of the object 200 in the X, Y, and Z directions.

As noted above, an example composite material drape-forming model/geodesic strain quantification pair corresponds to a unit vector field-based model/mathematical divergence quantification pair (e.g., based on parameterized triangulated part geometry).

In this regard, an example of the vector field logic 310 is configured to determine or generate a unit vector field 317 associated with the surface of the object 200 based on the adjusted parametric model 312 of the object 200. An example of the unit vector field 317 corresponds to a unit vector field where the magnitude of each vector in the field is one. An example of the unit vector field 317 associated with the object 200 of FIG. 2A is illustrated in FIG. 4A. In an example, determining the unit vector field 317 involves generating a drape-forming process model based on the shape of the object 200 and a type of manufacturing process data (i.e., manufacturing process data type 307) associated with the production of the object 200.

An example of the manufacturing process data type 307 specifies point, line, and/or region information, which further specifies one or more locations (e.g., points that define a contact region or contact line) of first contact associated with a drape-forming process. That is, these locations correspond to the region(s) where the material for forming the object 200 (e.g., flat sheet of material) first contacts the mandrel used for forming the object 200.

An example of a drape-forming process model, φ, used when the manufacturing process data type 307 specifies point, line and/or region information corresponds to a solution of an Eikonal model given by:

|∇φ|=1; and

φ|_{I}=0

where I corresponds to an initial contact location.

In this instance, an example of a technique for determining the unit vector field 317 associated with the surface of the object 200 involves computing a gradient of the drape-forming process model.

Another example of the manufacturing process data type 307 specifies a drape direction, D. The drape direction specifies the direction a flat material (i.e., material for forming the object) moves as the flat material comes down onto the mandrel. An example of a drape-forming process model, ϕ, used when the manufacturing process data type 307 specifies the drape direction, is given by:

ϕ=(S−p)·D

where p corresponds to a point in a plane perpendicular to D above a surface, S, of the mandrel. In this example, it may not be necessary to identify an initial contact location because the initial contact location is defined implicitly by p and D as the region on the part where ϕ is minimal.

In this instance, an example of a technique for determining the unit vector field 317 associated with the surface of the object involves computing a gradient of the drape-forming process model and normalizing the computed gradient to produce a unit vector field 317 as expressed by:

R=∇f/|∇f|

where f corresponds to the drape-forming process model, ϕ.

The divergence logic 315 is configured to adjust parameters of the parametric model 133 to reduce the divergence of the unit vector field 317. An example of the divergence logic 315 adjusts the radius of the fillet 205 of the parametric model 133 within a particular region 207 associated with the object 200 to reduce the average divergence of the unit vector field 317 to a minimum amount.

FIG. 4B illustrates an example of the geodesic curves 450 aligned with drape directions of the object 200 after adjustment of the parameters. As shown, the spacing between adjacent paths of the geodesic curves 450 of the object 200 is more uniform than the paths of the geodesic curves 250 of the object 200 illustrated in FIG. 2B. Thus, the excess material originally present at the end of the ramp has been eliminated or substantially reduced, indicating less compression build-up in on the flange at the end of the ramp. And the amount of spreading between the paths at the start of the ramp has been eliminated or substantially reduced, indicating less tension build-up at the start of the ramp.

In an example, the divergence logic 315 is configured to determine a value of an objective function associated with the divergence of the unit vector field 317, and to output parameter adjustments 319 to the parametric modeler 305. In an example, determination of the value of an objective function involves determining an average magnitude of the divergence over the surface, S, of the object 200 for a fillet 205 with radii schedule r according to:

$$F ( r ) = \frac{1}{A ( S ( r ) )} {\int }_{S ( r )} \vert ∇ \cdot R ( r ) \vert$$

wherein R corresponds to the unit vector field determined above, and S corresponds to a parameterized surface representation. The radii schedule r corresponds to a vector of radii values for the fillet along the length of the fillet.

In an example, the parametric modeler 305 is configured to adjust the radius of the fillet of the parametric model 133 associated the object 200 based on the parameter adjustments 319 and through successive iterations to minimize the value output by the divergence logic 315.

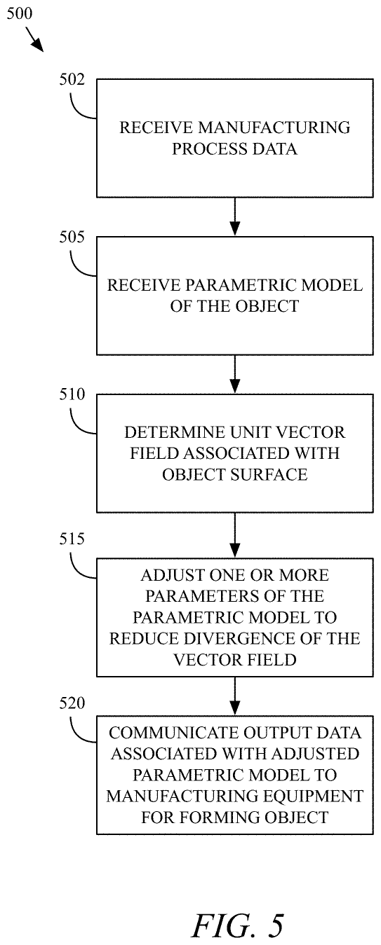

FIG. 5 illustrates examples of operations (e.g., a method) 500 performed by an example of the SOS 102 that facilitate optimizing the shape of an object 200. It should be understood that one or more of the operations can be implemented in instruction code that can be stored in the memory of the respective systems. The instruction code can be executed by one or more processors of these systems, alone or in combination with other subsystems of these systems, to cause the respective systems to perform the operations illustrated in the figures.

At block 502, manufacturing process data is received. For instance, in an example, the parametric modeler 305 of the SOS 102 receives manufacturing process data 134. An example of the manufacturing process data 134 specifies point, line, and/or region information, which further specifies one or more locations (e.g., points that define a contact region or contact line) of first contact associated with a drape-forming process. Another example of the manufacturing process data 134 specifies a drape direction, D. The drape direction specifies the direction a flat material (i.e., material for forming the object) moves as the flat material comes down onto the mandrel.

At block 505, a parametric model associated with the object is received. For instance, in an example, the parametric modeler 305 of the SOS 102 receives the parametric model 133. As noted above, the parametric model 133 defines the shape of an object 200 to be formed. An example of the parametric model 133 is specified in a file format such as a DXF file format or similar file format that facilitates specification of 3-dimensional objects and attributes associated with the object 200. An example of the parametric model 133 represents the object 200 via constructive solid geometry (CSG). Another example of the parametric model 133 represents the object 200 via boundary representation (BR).

At block 510, a unit vector field 317 associated with the object surface is determined. For instance, an example of the vector field logic 310 of the SOS 102 determines or generates a unit vector field 317 associated with the surface of the object based on the parametric model 133 of the object 200. As noted above, an example of the unit vector field 317 corresponds to a unit vector field where the magnitude of each vector in the field is one. In an example, determining the unit vector field 317 involves generating a drape-forming process model based on the shape of the object 200 and a manufacturing process data type 307 associated with the production of the object 200. As noted above, a first manufacturing process data type 307 specifies point, line, and/or region information. A second manufacturing process data type 307 specifies a drape direction, D.

An example of the drape-forming process model corresponds to a solution of an Eikonal model, as described above. In another example, the drape-forming process model is expressed as:

ϕ=(S−p)·D

where p corresponds to a point in a plane perpendicular to D above a surface, S, of the mandrel. In an example, determining the unit vector field 317 further involves computing the gradient of the drape-forming process model and normalizing the computed gradient to produce a unit vector field 317.

At block 515, one or more parameters of the parametric model 133 are adjusted to reduce the divergence of the unit vector field 317. For example, as noted above, an example of the parametric modeler 305 facilitates adjustment of one or more attributes associated with the parametric model 133, such as the scale of the object 200 in the X, Y, and Z directions. In an example, the parametric modeler 305 facilitates specification or adjustment of the radius of the fillet 205 of the object 200 within a particular region 207 of the object 200. In some examples, the adjusted radius of the fillet is maintained within a predetermined upper limit and a predetermined lower limit. For instance, in an example, the predetermined upper limit and the predetermined lower limit are specified by a designer. In an example, the predetermined upper limit and the predetermined lower limit are specified in the parametric model 133 communicated to the SOS 102.

The parametric modeler 305 adjusts parameters of the parametric model 133 to reduce the divergence of the unit vector field 317. An example of the parametric modeler 305 adjusts the radius of the fillet 205 of the parametric model 133 within a particular region 207 associated with the object 200 to reduce the average divergence of the unit vector field 317 to a minimum amount.

In an example, the divergence logic 315 is configured to determine a value of an objective function associated with the divergence of the unit vector field 317. In an example, the value of the objective function involves determining an average magnitude of the divergence over the surface, S, of the object 200 for a fillet 205 with radius schedule r according to:

$$F ( r ) = \frac{1}{A ( S ( r ) )} {\int }_{S ( r )} \vert ∇ \cdot R ( r ) \vert$$

wherein R corresponds to the unit vector field determined above, and S corresponds to a parameterized surface representation.

The parametric modeler 305 is configured to adjust the radius of the fillet of the parametric model 133 associated the object 200 through successive iterations to minimize the value output by the divergence logic 315.

At block 520, output data associated with the adjusted parametric model is communicated to manufacturing equipment for forming the object. For instance, an example of the SOS 102 communicates a file that specifies object formation data 142 associated with the adjusted parametric model 312 to object forming equipment 150, such as a CNC milling machine. An example of the object forming data 142 is specified in a file having a format such as a Drawing Exchange Format (DXF) or another file format that facilitates 3-dimensional representation of an object 200. An example of the object to be formed by the object forming equipment 150 corresponds to a mandrel that can be used in subsequent manufacturing operations to form a complementary object 200 via, for example, a drape forming process.

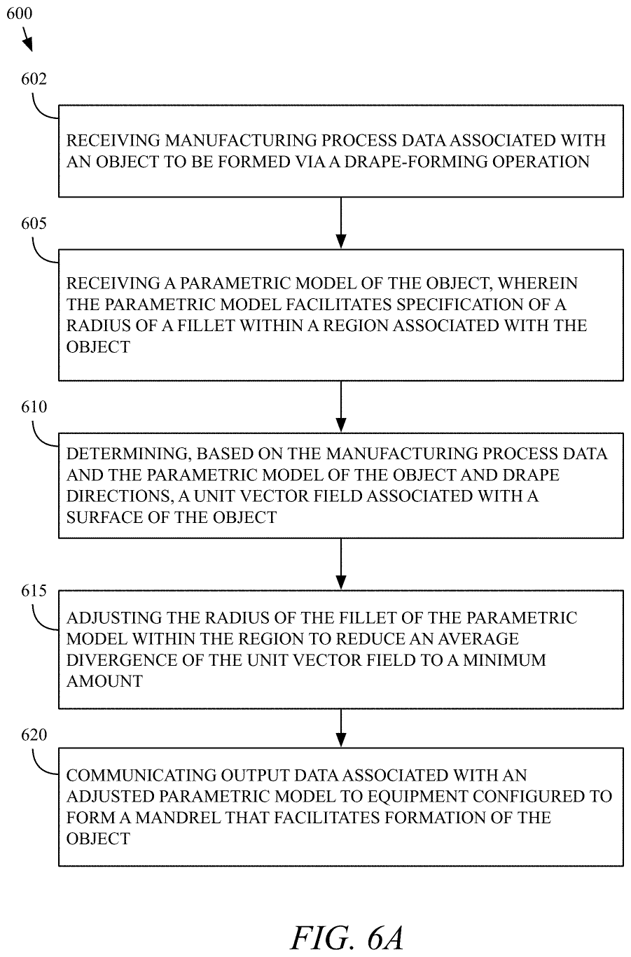

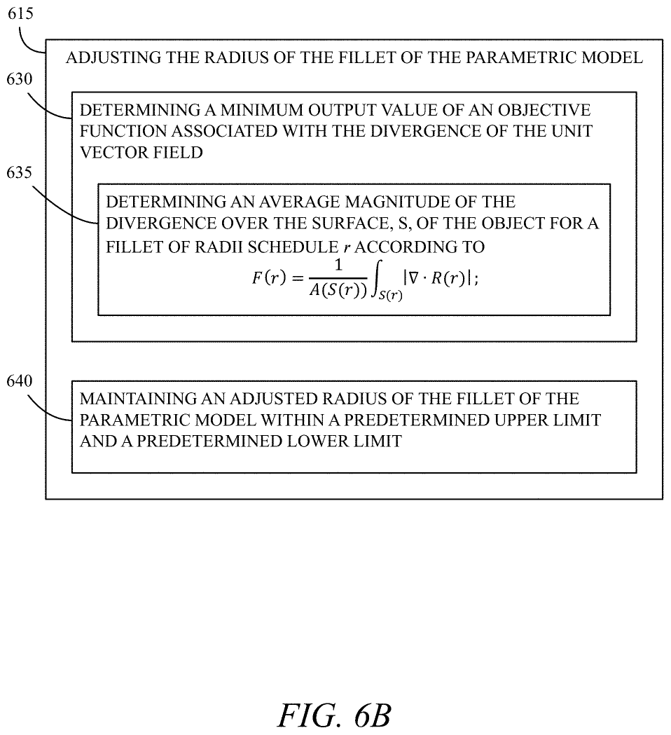

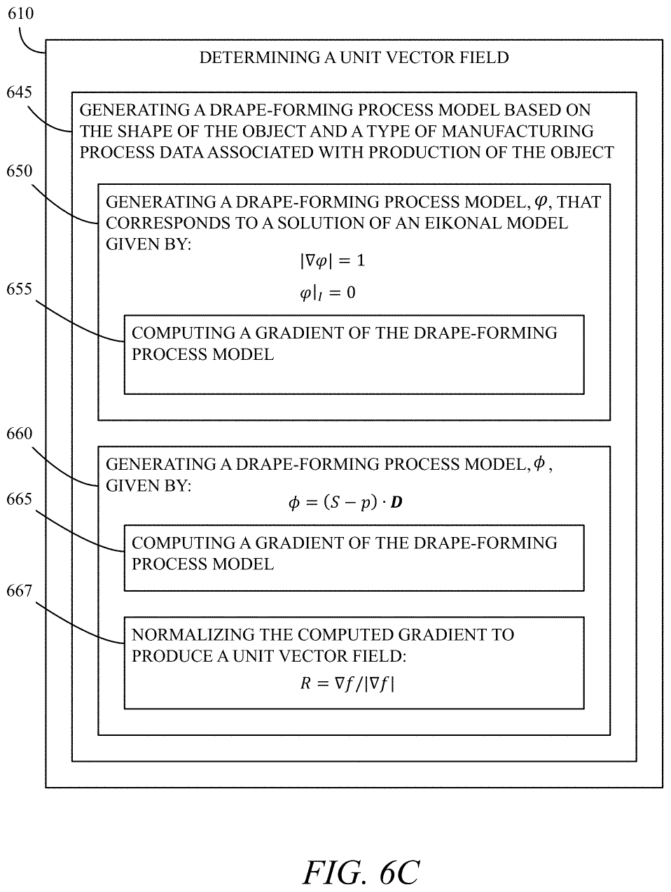

FIGS. 6A-6C illustrate example operations 600 of a computer-implemented method performed by a computing system such as one or more examples of the SOS 102 described above. Block 602 involves receiving, by the computing system, manufacturing process data associated with an object to be formed via a drape-forming operation.

Block 605 involves receiving, by the computing system, a parametric model of the object. The parametric model facilitates specification of a radius of a fillet within a region associated with the object.

Block 610 involves determining, by the computing system and based on the parametric model of the object, a unit vector field associated with a surface of the object.

Block 615 involves adjusting, by the computing system, the radius of the fillet of the parametric model within the region to reduce an average divergence of the vector field to a minimum amount.

Block 620 involves communicating, by the computing system, output data associated with an adjusted parametric model to equipment configured to form a mandrel that facilitates formation of the object.

As shown in block 615, in some examples, adjusting the radius of the fillet of the parametric model within the region to reduce the average divergence of the vector field to the minimum amount involves determining 630 a minimum output value of an objective function associated with the divergence of the vector field.

As shown in block 635, in some examples, determining the minimum output value of the objective function involves determining an average magnitude of the divergence over the surface, S, of the object for a fillet of radii r schedule according to:

$$F ( r ) = \frac{1}{A ( S ( r ) )} {\int }_{S ( r )} \vert ∇ \cdot R ( r ) \vert ;$$

and
minimizing F(r), wherein R corresponds to the unit vector field, and S corresponds to a parameterized surface representation.

In some examples, adjusting 615 the radius of the fillet of the parametric model within the region of the object to reduce the average divergence of the vector field to the minimum amount involves maintaining 640 an adjusted radius of the fillet of the parametric model within a predetermined upper limit and a predetermined lower limit.

In some examples, determining 610 the unit vector field associated with the surface of the object further involves generating 645 a drape-forming process model based on the shape of the object and a type of manufacturing process data associated with production of the object.

In some examples, when the type of manufacturing process data specifies one or more of point, line or region information that specifies one or more locations of first contact associated with a drape-forming process, generating 645 the drape-forming process model further involves generating 650 a drape-forming process model, φ, that corresponds to a solution of an Eikonal model given by:

|∇φ|=1; and

φ|_{I}=0

where I corresponds to an initial contact location.

In some examples, generating 650 a drape-forming process model, φ, that corresponds to a solution of an Eikonal model involves computing 655 a gradient of the drape-forming process model.

In some examples, when the type of manufacturing process data specifies a drape direction, D, that specifies a direction a flat material moves as the flat material comes down onto the mandrel, generating 645 the drape-forming process model further involves generating 660 a drape-forming process model, ϕ, given by:

ϕ=(S−p)·D

where p corresponds to a point in a plane perpendicular to D above a surface, S, of the mandrel. In this example, it may not be necessary to identify an initial contact location because the initial contact location is defined implicitly by p and D as the region on the part where ϕ is minimal.

In some examples, generating 660 the drape-forming process model, ϕ, involves computing 665 a gradient of the drape-forming process model and, normalizing 667 the computed gradient to produce a unit vector field:

R=∇f/|∇f|

wherein f corresponds to the drape-forming process model, ϕ.

As noted above, another example of a composite material drape-forming model/geodesic strain quantification pair corresponds to a unit vector field-based model/geodesic angle alignment quantification pair (e.g., based on parameterized chain-of-diamonds fillet geometry).

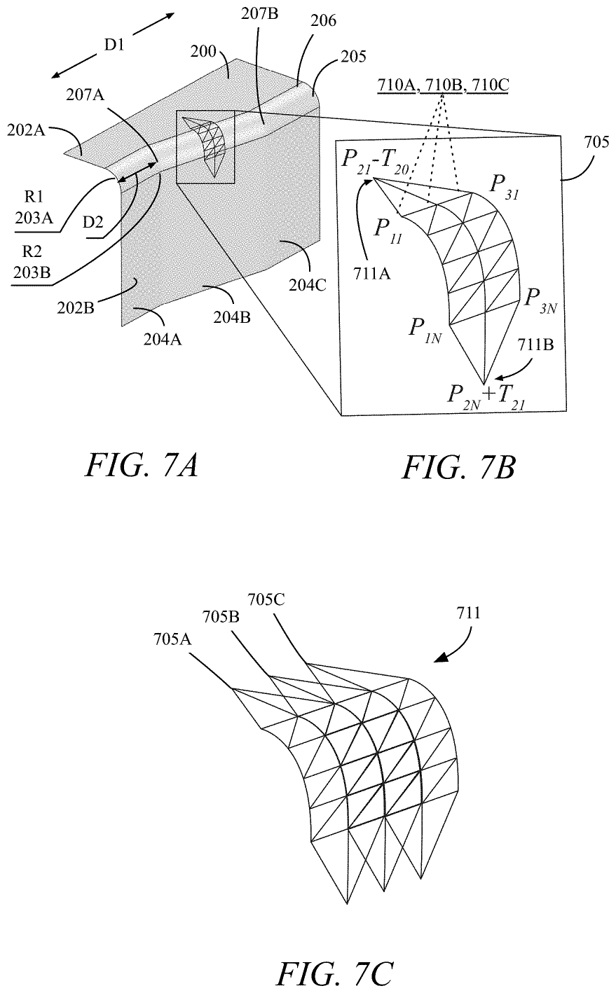

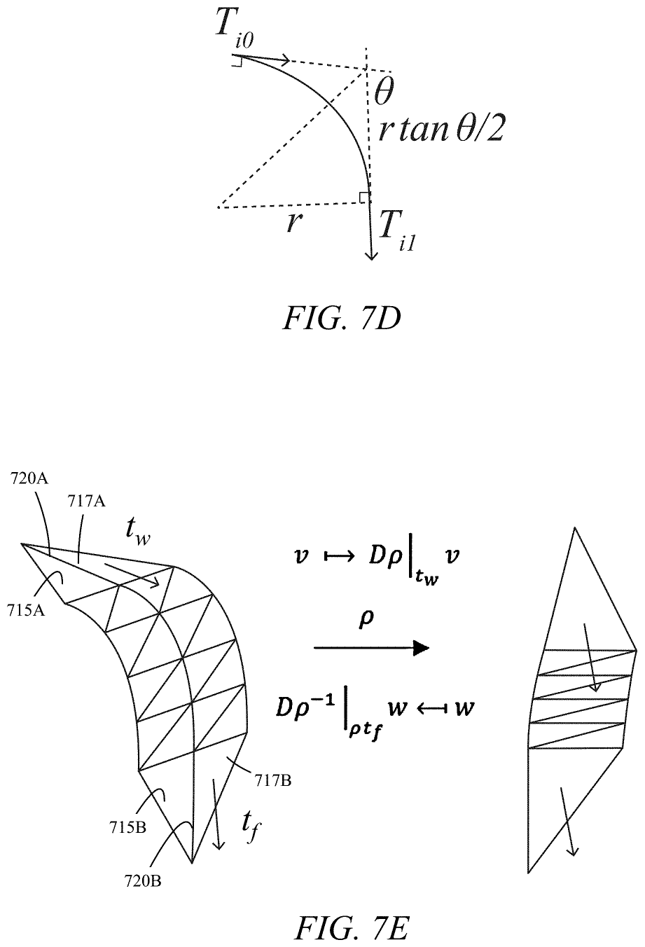

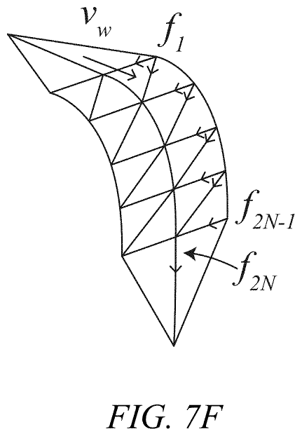

FIGS. 7A-7E illustrate principles of this technique. According to this implementation, the fillet 205 is represented in a unique geometric form that facilitates computationally efficient optimization of the radius of the fillet 205 to minimize the formation of wrinkles in the object 200 and thereby increase the strength of the object 200.

In this regard, a geodesic on a three-dimensional surface is equivalent to a straight line in the plane: it is a least energy path connecting two points. The ratio of the distance between neighboring geodesics within various surfaces of the object gives a simple geometric measure of the strain or geodesic strain in the material perpendicular to the geodesics. If a function, F, that relates a fillet radius schedule on an object 200 to this geodesic strain of the object 200 can be determined, then “fillet radius schedule design” can be performed by minimizing F with standard optimization solvers.

A fast-to-compute model that captures the essentials of the dependence of geodesic strain on a fillet radius schedule can be obtained by simplifying the geometry of the object in two ways.

Referring to FIG. 7A, the first simplification arises when the only variations in the shape of the top surface 202A and the side surface 202B of the object 200 occur in the longitudinal direction, D1, of the object 200, so that in a drape that moves from the top surface 202A to the side surface 202B, material will generally not encounter new shape features after the drape of the fillet 205 is complete.

The second simplification arises from the fact that the optimization will require many fewer evaluations of F if the derivative, DF, can be computed. The derivative of geodesic-shooting cannot be determined because a geodesic will enter different triangles depending on the geometry and initial direction. Therefore, in an example, the detailed geometry representation of the surface of the fillet, S, is replaced/represented with a much simpler model of the fillet 205 over which geodesic directions can be traced.

FIG. 7B illustrates an example of the geometry (hereinafter diamond 705) used to represent the fillet 205. Referring to the figure, let c₁ (t), c₂(t), and c₃(t), t ∈ [0,1] be three consecutive circle-arc cross-sections (710A, 710B, 710C) of the fillet 205 oriented from the top surface 202A to the side surface 202B, so cᵢ (0) is on the boundary between the top surface 202A and the fillet 205 and cᵢ (1) is on the boundary between the fillet 205 and the side surface 202B. Let Tᵢ₀ and Tᵢ₁ be the unit tangents of cᵢ at t=0,1 respectively. Fix an integer N>1 and let pᵢⱼ for 1≤j≤N, be N equally-spaced samples of cᵢ. A single unit, or diamond 705, in the simplified model is a triangulation with nodes pᵢⱼ and p₂₁−T₁₀, p_{2N}+T₁₁, for 1≤i≤3 and 1≤j≤N.

As illustrated in FIG. 7C, these diamonds (705A, 705B, 705C) fit together into a non-manifold model 711 of the fillet 205 such that edges along the boundary between the top surface 202A and fillet 205 and the fillet 205 and side surface 202B have three adjacent triangles.

As illustrated in FIG. 7D, in cross-section i, if the tangent directions Tᵢ₀ and Tᵢ₁ are fixed, then it is relatively straightforward to vary the radius, r, of the arc.

As illustrated in FIG. 7E, it is also possible on a single diamond 705 to transport directions from the top surface 202A to the side surface 202B. Let t_{w} be one of the top surface triangles 715A in diamond 705 and t_{f} the corresponding side surface triangle 715B. There is an unwrapping map p that sends the half of the diamond 705 in which t_{w} and t_{f} live isometrically to the plane. A vector v_{w} in t_{w} can be transported to t_{f} by applying the derivatives of ρ and ρ⁻¹. In particular, the transported vector is:

v_{f}=Dρ⁻¹|_{ρt}_{_{f}}Dρ|ₜ_{_{w}}v_{w}.

Therefore, for each diamond 705, Dᵢ, in the chain of diamonds 711, there are two top surface directions v_{w1}ⁱ and v_{w2}ⁱ that can be transported to side surface directions v_{f1}ⁱ and v_{f2}ⁱ respectively. Note that the side surface directions depend on the three fillet radii that define the fillet of Dᵢ. To highlight this dependence we write v_{f1}ⁱ(r) and v_{f2}ⁱ(r) for some radius vector r. Let Rᵢ be the rotation about the edge 720B between side surface triangles (715B, 717B) t_{f1}ⁱ and t_{f2}ⁱ that align t_{f2}ⁱ with t_{f1}ⁱ. In order to reduce geodesic strain, cross-section fillet radii are chosen so that on each diamond 705 the two directions transported to the side surface 202B are as parallel as possible. This leads to the following aggregate objective:

$$F ( r ) = {\sum }_{i} {( {v}_{{f}^{1}}^{i} ( r ) \cdot {R}_{i} {{v}_{{f}^{2}}^{i} ( r )}^{⊥} )}^{2} .$$

Each summand of F is the dot product of the first transported vector with the vector perpendicular to the second transported vector (in its side surface triangle 717B) rotated into the plane of the first side surface triangle 715B.

Referring to FIG. 7F, as long as orientations are carefully accounted for, it's possible to work with angles directly. For example, let fⁱ for 1≤j≤2N−1 be vectors along the edges of the triangles making up the fillet 205, and let f_{2N} be the tangent vector T₁₁. Then the angle between f_{2N} and the transport of v_{w} to the side surface can be expressed as:

$$∠ {f}_{2 N} {v}_{f} = ∠ {f}_{1} {v}_{w} + {\sum }_{1 \leq j \leq 2 N} ∠ {f}_{j + 1} {f}_{j} .$$

Each angle in the above sum is oriented by the normal of the corresponding triangle of the diamond 705. Using these angles result in the following objective function:

$${F}_{θ} ( r ) = {\sum }_{i} {( ∠ {f}_{2 N}^{i} {v}_{f 1} ( r ) - ∠ {f}_{2 N}^{i} {v}_{f 2} ( r ) )}^{2}$$

The summands in the above expression capture the desire to have the transported angles relative to f_{2N} be the same.

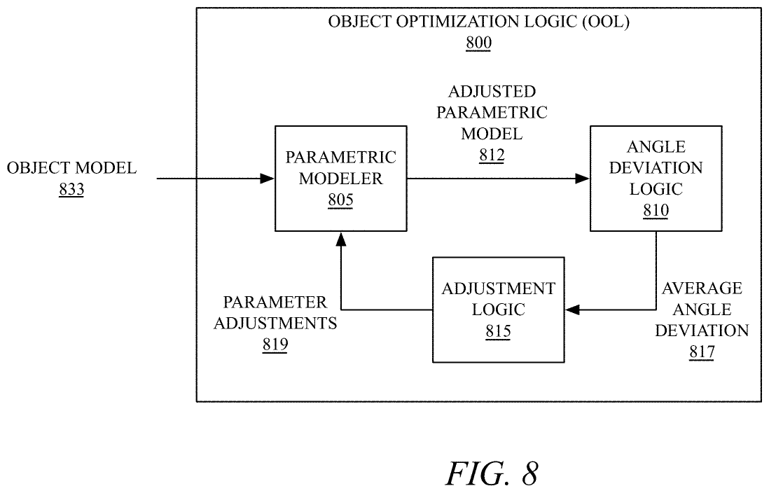

FIG. 8 is an example of a logical representation of an OOL 800 that optimizes the shape of an object 200 according to the methodology described above. The OOL 800 includes a parametric modeler 805, angle deviation logic 810, and adjustment logic 815. An example of the OOL 800 can be utilized in connection with the shape optimization system 102 described above in FIG. 1.

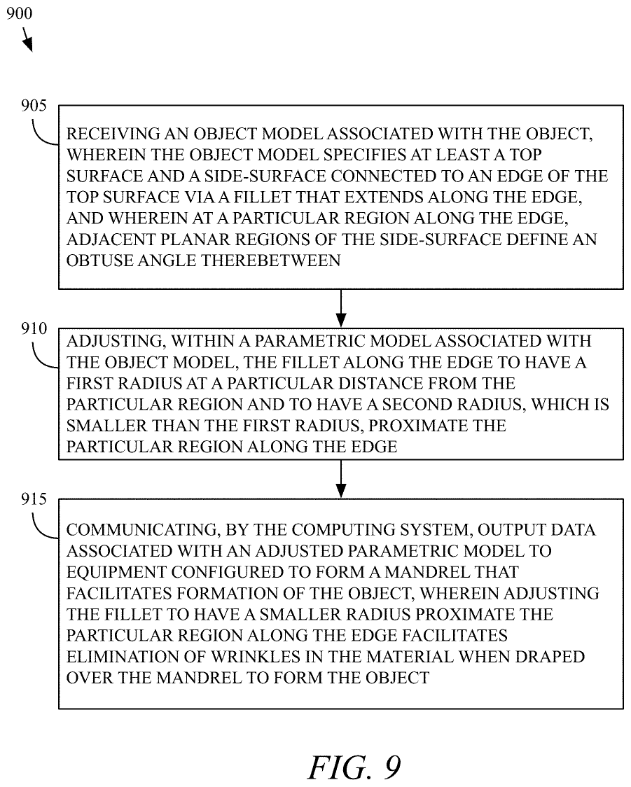

FIGS. 9-13 illustrate operations (e.g., a method) 900 performed by one or more of the parametric modeler 805, angle deviation logic 810, and adjustment logic 815 that facilitate implementation of the shape optimization methodology. It should be understood that one or more of the operations can be implemented in instruction code that can be stored in the memory of a respective systems. The instruction code can be executed by one or more processors of these systems, alone or in combination with other subsystems of these systems, to cause the respective systems to perform the operations illustrated in the figures.

Referring to FIG. 9, at block 905, an object model 833 associated with the object 200 is received. The object model 833 specifies at least a top surface 202A and a side surface 202B connected to an edge 206 of the top surface 202A via a fillet 205 that extends along the edge 206. At a particular or first region 207A along the edge 206, adjacent planar regions (204A, 204B) of the side surface 202B define an obtuse angle (i.e., an angle less than 180 degrees) therebetween. An example of the object model 833 can be specified in any of the file formats described above.

At block 910, the fillet 205 specified within a parametric model associated with the object model 833 is adjusted along the edge 206 to have a first radius 203A, R1, at a particular distance, D2, from the first region 207A and to have a second radius 203B, R2, which is smaller than the first radius 203A, R1, proximate the first region 207A along the edge 206.

At block 915, output data 142 associated with an adjusted parametric model 812 is communicated to equipment 150 configured to form a mandrel that facilitates formation of the object 200. Adjusting the fillet 205 to have a smaller radius proximate the first region 207A along the edge 206 facilitates elimination of wrinkles in the material when draped over the mandrel to form the object 200 and thereby increase the strength of object 200.

In operation, certain aspects above are performed iteratively. For instance, in an example, the parametric modeler 805 is configured to receive the object model 833. During a first iteration, the object model 833 is communicated to the angle deviation logic 810. The angle deviation logic 810 is configured to determine and output an average angle deviation 817 associated with a fillet 205 of the object 200. The adjustment logic 815 is configured to receive the average angle deviation 817 and to determine and output parameter adjustments 819 to the parametric modeler 805.

During a second iteration, the parameter adjustments 819 determined during the first iteration are used by the parametric modeler 805 to adjust parameters associated the fillet 205 (e.g., one or more radii associated with the fillet 205 along the edge 206 of the object 200). The parametric modeler 805 outputs an adjusted parametric model 812 that is adjusted according to the parameter adjustments 819. The angle deviation logic 810 determines the average angle deviation 817, and the adjustment logic 815 determines further parameter adjustments 819 based on the average angle deviation 817. These operations repeat until the average angle deviation 817 reaches a minimum value. When the minimum value is reached, the radii associated with the fillet 205 along the edge 206 of the object 200 have values that minimize the formation of wrinkles in the object 200 and thereby increase the strength of the object 200.

For example, referring to FIG. 7A, the radius of the fillet 205 at a distance D2 from a first region 207A, may in an example be adjusted to be 10 mm and the radius of the fillet 205 at the first region 207A (i.e., the region where adjacent planar regions (204A, 204B) of the side surface 202B define an angle less than 180 degrees) may be adjusted to be 5 mm. The radius of the fillet 205 may be adjusted to gradually transition between 10 mm at a distance D2 from the first region 207A to 5 mm at the first region 207A. The radius of the fillet 205 may then be adjusted to gradually increase from 5 mm at the first region 207A to 10 mm or higher at a second region 207B where corresponding adjacent planar regions (204B, 204C) of the side surface 202B from an angle greater than 180 degrees with one another.

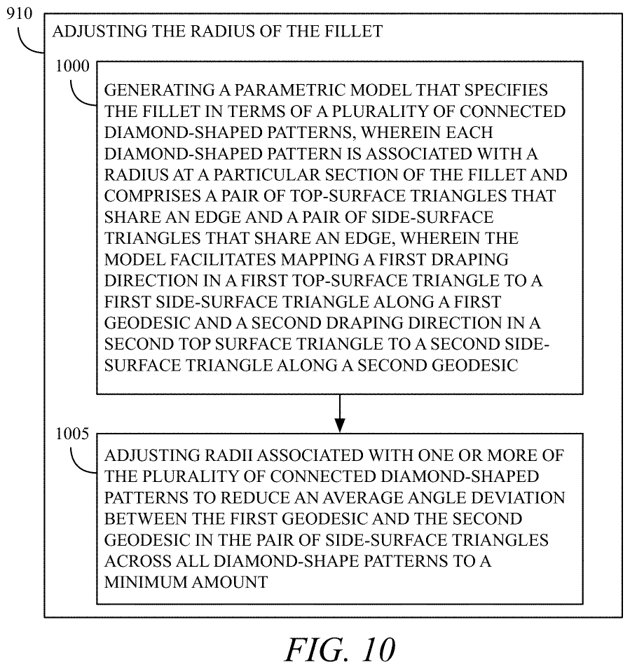

Referring to FIG. 10, in an example, adjusting the radius of the fillet 205 at block 910, comprises, at block 1000, generating a parametric model 812 that specifies the fillet 205 in terms of a plurality of connected diamond-shaped patterns (705A, 705B, 705C). Each diamond-shaped pattern (705A, 705B, 705C) is associated with a radius at a particular section of the fillet 205 and comprises a pair of top-surface triangles (715A, 717A) that share an edge 720A and a pair of side surface triangles (715B, 717B) that share an edge 720B. The parametric model 812 facilitates mapping a first draping direction, t_{w}, in a first top-surface triangle 715A to a first side surface triangle 715B along a first geodesic and a second draping direction in a second top surface triangle 717A to a second side surface triangle 717B along a second geodesic. An example of the parametric modeler 805 is configured to specify the fillet 205 in terms of a plurality of connected diamond-shaped patterns (705A, 705B, 705C), as described above.

At block 1005, radii associated with one or more of the plurality of connected diamond-shaped patterns (705A, 705B, 705C), are adjusted to reduce an average angle deviation 817 between the first geodesic and the second geodesic in the pair of side surface triangles (715B, 717B) across all diamond-shaped patterns (705A, 705B, 705C), to a minimum amount.

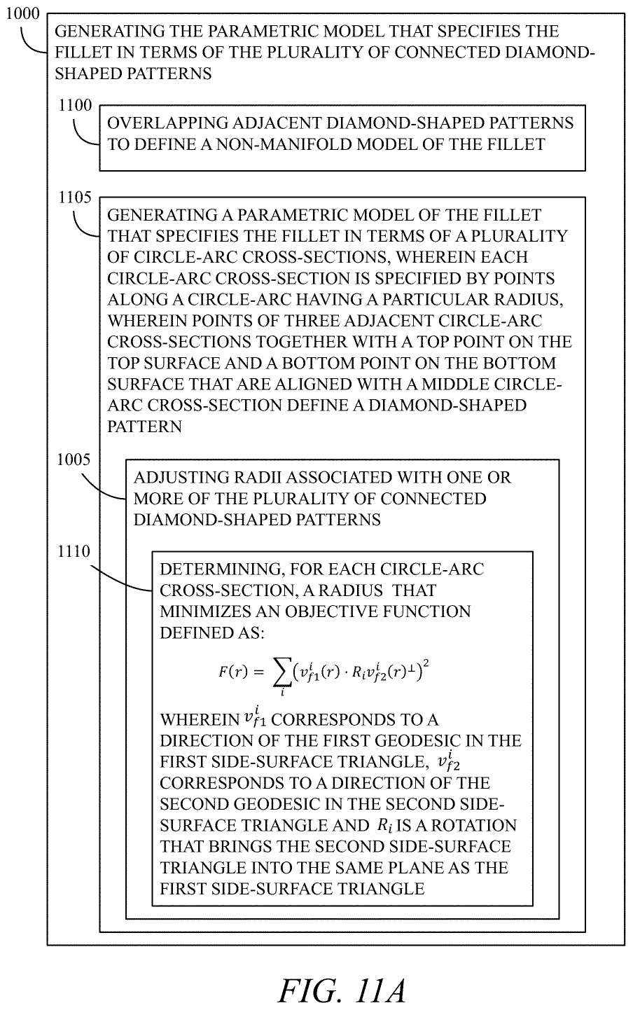

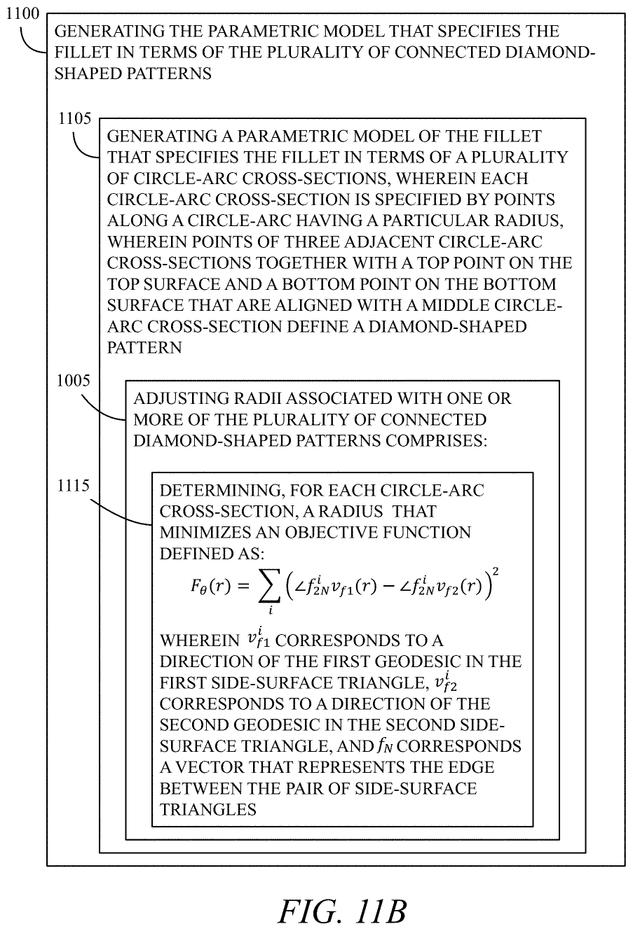

Referring to FIGS. 11A and 11B, in an example, generating the parametric model 812 that specifies the fillet 205 in terms of the plurality of connected diamond-shaped patterns (705A, 705B, 705C), at block 1000, comprises, at block 1100, overlapping adjacent diamond-shaped patterns (705A, 705B, 705C), to define a non-manifold model 711 of the fillet 205.

In another example, generating the parametric model 812 that specifies the fillet 205 in terms of the plurality of connected diamond-shaped patterns (705A, 705B, 705C), at block 1000 comprises, at block 1105, generating a parametric model 812 of the fillet 205 that specifies the fillet in terms of a plurality of circle-arc cross-sections (710A, 710B, 710C). Each circle-arc cross-section (710A, 710B, 710C) is specified by points along a circle-arc having a particular radius. Points of three adjacent circle-arc cross-sections (710A, 710B, 710C) together with a top point 711A on the top surface 202A and a bottom point 711B on the side surface 202B that are aligned with a middle circle-arc cross-section 710B define a diamond-shaped pattern (705A, 705B, 705C).

In this example, adjusting radii associated with one or more of the plurality of connected diamond-shaped patterns (705A, 705B, 705C), at block 1005 comprises, at block 1110, determining, for each circle-arc cross-section (710A, 710B, 710C), a radius r that minimizes an objective function defined as:

$$F ( r ) = {\sum }_{i} {( {v}_{{f}^{1}}^{i} ( r ) \cdot {R}_{i} {{v}_{{f}^{2}}^{i} ( r )}^{⊥} )}^{2}$$

where v_{f1}ⁱ corresponds to a direction of the first geodesic in the first side surface triangle 715B, v_{f2}ⁱ corresponds to a direction of the second geodesic in the second side surface triangle 717B and Rᵢ is a rotation that brings the second side surface triangle 717B into the same plane as the first side surface triangle 715B.

In another example, adjusting radii associated with one or more of the plurality of connected diamond-shaped patterns (705A, 705B, 705C), at block 1005 comprises, at block 1115, determining, for each circle-arc cross-section (710A, 710B, 710C), a radius r that minimizes an objective function defined as:

$${F}_{θ} ( r ) = {\sum }_{i} {( ∠ {f}_{2 N}^{i} {v}_{f 1} ( r ) - ∠ {f}_{2 N}^{i} {v}_{f 2} ( r ) )}^{2}$$

where v_{f1}ⁱ corresponds to a direction of the first geodesic in the first side surface triangle 715B, v_{f2}ⁱ corresponds to a direction of the second geodesic in the second side surface triangle 717B, and f_{N} corresponds a vector that represents the edge 720B between the pair of side surface triangles.

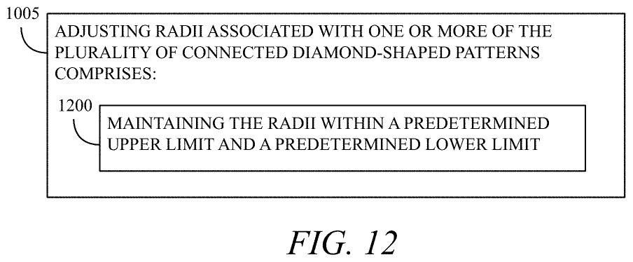

Referring to FIG. 12, in an example, adjusting radii associated with one or more of the plurality of connected diamond-shaped patterns (705A, 705B, 705C), at block 1005 comprises, at block 1200, maintaining the radii within a predetermined upper limit and a predetermined lower limit.

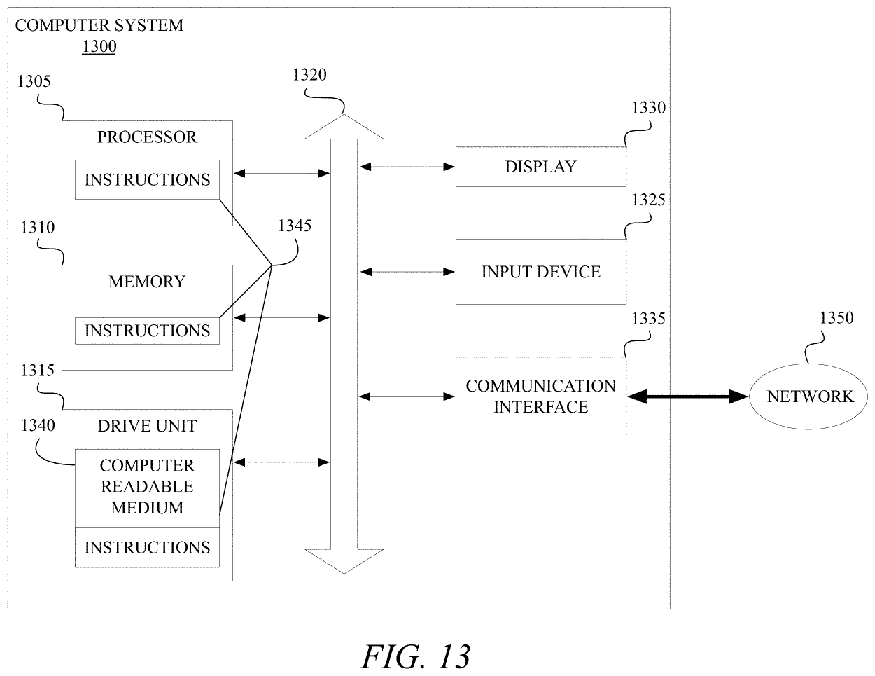

FIG. 13 illustrates an example of a computer system 1300 that can form part of or implement any of the systems and/or devices described above. The computer system 1300 can include a set of instructions 1345 that the processor 1305 can execute to cause the computer system 1300 to perform any of the operations described above. An example of the computer system 1300 can operate as a stand-alone device or can be connected, e.g., using a network, to other computer systems or peripheral devices.

In a networked example, the computer system 1300 can operate in the capacity of a server or as a client computer in a server-client network environment, or as a peer computer system in a peer-to-peer (or distributed) environment. The computer system 1300 can also be implemented as or incorporated into various devices, such as a personal computer or a mobile device, capable of executing instructions 1345 (sequential or otherwise), causing a device to perform one or more actions. Further, each of the systems described can include a collection of subsystems that individually or jointly execute a set, or multiple sets, of instructions to perform one or more computer operations.

The computer system 1300 can include one or more memory devices 1310 communicatively coupled to a bus 1320 for communicating information. In addition, code operable to cause the computer system to perform operations described above can be stored in the memory 1310. The memory 1310 can be random-access memory, read-only memory, programmable memory, hard disk drive, or any other type of memory or storage device.

The computer system 1300 can include a display 1330, such as a liquid crystal display (LCD), a cathode ray tube (CRT), or any other display suitable for conveying information. The display 1330 can act as an interface for the user to see processing results produced by processor 1305.

Additionally, the computer system 1300 can include an input device 1325, such as a keyboard or mouse or touchscreen, configured to allow a user to interact with components of system 1300.

The computer system 1300 can also include a disk or optical drive unit 1315. The drive unit 1315 can include a computer-readable medium 1340 in which the instructions 1345 can be stored. The instructions 1345 can reside completely, or at least partially, within the memory 1310 and/or within the processor 1305 during execution by the computer system 1300. The memory 1310 and the processor 1305 also can include computer-readable media as discussed above.

The computer system 1300 can include a communication interface 1335 to support communications via a network 1350. The network 1350 can include wired networks, wireless networks, or combinations thereof. The communication interface 1335 can enable communications via any number of wireless broadband communication standards, such as the Institute of Electrical and Electronics Engineering (IEEE) standards 802.11, 802.12, 802.16 (WiMAX), 802.20, cellular telephone standards, or other communication standards.

Further object optimization methodologies for minimizing the formation of wrinkles in an object 200 and thereby increase the strength of the object 200 are elucidated in the following clauses.

Clause 1. A method (500, 600) implemented by a computing system (102) that facilitates formation of an object (200), the method comprising:

receiving (502, 602), by the computing system (102), manufacturing process data (134) associated with an object (200) to be formed via a drape-forming operation;

receiving (505, 605), by the computing system (102), a parametric model (312) of the object (200), wherein the parametric model (312) facilitates specification of a radius of a fillet (205) within a region (207) associated with the object (200);

determining (510, 610), by the computing system (102) and based on the manufacturing process data (134) and the parametric model (312) of the object (200), a unit vector field (317) associated with a surface of the object (200);

adjusting (515, 615), by the computing system (102), the radius of the fillet (205) of the parametric model (312) within the region (207) to reduce an average divergence of the unit vector field (317) to a minimum amount; and communicating (520, 620), by the computing system (102), output data (142) associated with an adjusted parametric model (312) to equipment (150) configured to form a mandrel that facilitates formation of the object (200).

Clause 2. The method according to clause 1, wherein adjusting the radius of the fillet (205) of the parametric model (312) within the region (207) to reduce the average divergence of the unit vector field (317) to the minimum amount comprises:

determining (630) a minimum output value of an objective function associated with the divergence of the unit vector field (317).

Clause 3. The method according to clause 2, wherein determining the minimum output value of the objective function comprises:

determining (635) an average magnitude of the divergence over the surface, S, of the object (200) for a fillet (205) of radii schedule r according to:

$$F ( r ) = \frac{1}{A ( S ( r ) )} {\int }_{S ( r )} \vert ∇ \cdot R ( r ) \vert ;$$

and

minimizing F (r), wherein R corresponds to the unit vector field (317), and S corresponds to a parameterized surface representation.

Clause 4. The method according to clause 1, wherein determining the unit vector field (317) associated with the surface of the object (200) further comprises:

generating (645) a drape-forming process model based on the shape of the object (200) and a type of manufacturing process data associated with production of the object (200).

Clause 5. The method according to clause 4, wherein when the type of manufacturing process data (307) specifies one or more of: point, line or region information that specifies one or more locations of first contact associated with a drape-forming process, generating the drape-forming process model further comprises:

generating (650) a drape-forming process model, φ, that corresponds to a solution of an Eikonal model given by:

|∇φ|=1; and

φ|_{I}=0

where I corresponds to an initial contact location.

Clause 6. The method according to clause 5, wherein determining the unit vector field (317) associated with the surface of the object (200) comprises:

computing (655) a gradient of the drape-forming process model.

Clause 7. The method according to clause 4, wherein when the type of manufacturing process data (307) specifies a drape direction, D, that specifies a direction a flat material moves as the flat material comes down onto the mandrel, generating the drape-forming process model further comprises:

generating (660) a drape-forming process model, ϕ, given by:

ϕ=(S−p)·D

where p corresponds to a point in a plane perpendicular to D above a surface, S, of the mandrel.

Clause 8. The method according to clause 7, wherein determining the unit vector field (317) associated with the surface of the object (200) comprises:

computing (665) a gradient of the drape-forming process model; and

normalizing (667) the computed gradient to produce a unit vector field (317):

R=∇f/|∇f|

wherein f corresponds to the drape-forming process model, ϕ.

Clause 9. The method according to clause 1, wherein adjusting the radius of the fillet (205) of the parametric model (312) within the region (207) of the object (200) to reduce the average divergence of the unit vector field (317) to the minimum amount comprises:

maintaining (640) an adjusted radius of the fillet (205) of the parametric model (312) within a predetermined upper limit and a predetermined lower limit.

Clause 10. A computing system (102) comprising:

a memory that stores instruction code; and

a processor in communication with the memory, wherein the instruction code is executable by the processor to cause the computing system (102) to perform operations comprising:
receiving (502, 602) manufacturing process data (134) associated with an object (200) to be formed via a drape-forming operation;
receiving (505, 605) a parametric model (312) of the object (200), wherein the parametric model (312) facilitates specification of a radius of a fillet (205) within a region (207) associated with the object (200);
determining (510, 610), based on the manufacturing process data (134) and the parametric model (312) of the object (200), a unit vector field (317) associated with a surface of the object (200);
adjusting (515, 615) the radius of the fillet (205) of the parametric model (312) within the region (207) to reduce an average divergence of the unit vector field (317) to a minimum amount; and
communicating (520, 620) output data associated with an adjusted parametric model (312) to equipment configured to form a mandrel that facilitates formation of the object (200).

Clause 11. The computing system (102) according to clause 10, wherein in adjusting the radius of the fillet (205) of the parametric model (312) within the region (207) to reduce the average divergence of the unit vector field (317) to the minimum amount, the instruction code causes the computing system (102) to perform operations comprising:

determining (630) a minimum output value of an objective function associated with the divergence of the unit vector field (317).

Clause 12. The computing system (102) according to clause 11, wherein in determining the minimum output value of the objective function, the instruction code causes the computing system (102) to perform operations comprising:

determining (635) an average magnitude of the divergence over the surface, S, of the object (200) for a fillet (205) of radii schedule r according to:

$$F ( r ) = \frac{1}{A ( S ( r ) )} {\int }_{S ( r )} \vert ∇ \cdot R ( r ) \vert ;$$

and

minimizing F(r), wherein R corresponds to the unit vector field (317), and S corresponds to a parameterized surface representation.

Clause 13. The computing system (102) according to clause 10, wherein in determining the unit vector field (317) associated with the surface of the object (200), the instruction code causes the computing system (102) to perform operations comprising:

generating (645) a drape-forming process model based on the shape of the object (200) and a type of manufacturing process data (307) associated with production of the object (200).

Clause 14. The computing system (102) according to clause 13, wherein when the type of manufacturing process data (307) specifies one or more of: point, line or region information that specifies one or more locations of first contact associated with a drape-forming process, in generating the drape-forming process model, the instruction code causes the computing system (102) to perform operations comprising:

generating (650) a drape-forming process model, φ, that corresponds to a solution of an Eikonal model given by:

|∇φ|=1; and

φ|_{I}=0

where I corresponds to an initial contact location.

Clause 15. The computing system (102) according to clause 14, wherein in determining the unit vector field (317) associated with the surface of the object (200), the instruction code causes the computing system (102) to perform operations comprising:

computing (655) a gradient of the drape-forming process model.

Clause 16. The computing system (102) according to clause 13, wherein when the type of manufacturing process data (307) specifies a drape direction, D, that specifies the direction a flat material moves as the flat material comes down onto the mandrel, in generating the drape-forming process model, the instruction code causes the computing system (102) to perform operations comprising:

generating (660) a drape-forming process model, ϕ, given by:

ϕ=(S−p)·D

where p corresponds to a point in a plane perpendicular to D above a surface, S, of the mandrel.

Clause 17. The computing system (102) according to clause 16, wherein in determining the unit vector field (317) associated with the surface of the object (200), the instruction code causes the computing system (102) to perform operations comprising:

computing (665) a gradient of the drape-forming process model; and

normalizing the computed gradient to produce a unit vector field (317):

R=∇f/|∇f|

wherein f corresponds to the drape-forming process model, ϕ.

Clause 18. The computing system (102) according to clause 10, wherein in adjusting the radius of the fillet (205) of the parametric model (312) within the region (207) of the object (200) to reduce the average divergence of the unit vector field (317) to the minimum amount, the instruction code causes the computing system (102) to perform operations comprising:

maintaining (640) an adjusted radius of the fillet (205) of the parametric model (312) within a predetermined upper limit and a predetermined lower limit.

Clause 19. A non-transitory computer-readable medium having stored thereon instruction code, wherein the instruction code is executable by a processor of a computing system (102) to cause the computing system (102) to perform operations comprising:
receiving (502, 602) manufacturing process data (134) associated with an object (200) to be formed via a drape-forming operation;
receiving (505, 605) a parametric model (312) of the object (200), wherein the parametric model (312) facilitates specification of a radius of a fillet (205) within a region (207) associated with the object (200);
determining (510, 610), based on the parametric model (312) of the object (200), a unit vector field (317) associated with a surface of the object (200);
adjusting (515, 615) the radius of the fillet (205) of the parametric model (312) within the region (207) to reduce an average divergence of the unit vector field (317) to a minimum amount; and

communicating (520, 620) output data associated with an adjusted parametric model (312) to equipment configured to form a mandrel that facilitates formation of the object (200).

Clause 20. The non-transitory computer-readable medium according to clause 19, wherein in adjusting the radius of the fillet (205) of the parametric model (312) within the region (207) to reduce the average divergence of the unit vector field (317) to the minimum amount, the instruction code is executable to cause the computing system (102) to perform operations comprising:
determining (620) a minimum output value of an objective function associated with the divergence of the unit vector field (317).

Accordingly, methods and systems described herein can be realized in hardware, software, or a combination of hardware and software. The methods and systems can be realized in a centralized fashion in at least one computer system or in a distributed fashion where different elements are spread across interconnected computer systems. Any kind of computer system or other apparatus adapted for carrying out the methods described herein can be employed.

The methods and systems described herein can also be embedded in a computer program product, which includes all the features enabling the implementation of the operations described herein and which, when loaded in a computer system, can carry out these operations. Computer program, as used herein refers to an expression, in a machine-executable language, code or notation, of a set of machine-executable instructions intended to cause a device to perform a particular function, either directly or after one or more of a) conversion of a first language, code, or notation to another language, code, or notation; and b) reproduction of a first language, code, or notation.

While the systems and methods of operation have been described with reference to certain examples, it will be understood by those skilled in the art that various changes can be made and equivalents can be substituted without departing from the scope of the claims. Therefore, it is intended that the present methods and systems not be limited to the particular examples disclosed, but that the disclosed methods and systems include all embodiments falling within the scope of the appended claims.

What is claimed is:

1. A method implemented by a computing system that facilitates formation of an object from a material, the method comprising:
receiving, by the computing system, an object model associated with the object, wherein the object model specifies at least a top surface and a side surface connected to an edge of the top surface via a fillet that extends along the edge, and wherein at a particular region along the edge, adjacent planar regions of the side surface define an obtuse angle therebetween;
adjusting, by the computing system and within a parametric model associated with the object model, the fillet along the edge to have a first radius at a particular distance from the particular region and to have a second radius, which is smaller than the first radius, proximate the particular region along the edge; and
communicating, by the computing system, output data associated with an adjusted parametric model to equipment configured to form a mandrel that facilitates formation of the object, wherein adjusting the fillet to have a smaller radius proximate the particular region along the edge facilitates elimination of wrinkles in the material when draped over the mandrel to form the object.

2. The method according to claim 1, wherein adjusting the radius of the fillet comprises:
generating a parametric model that specifies the fillet in terms of a plurality of connected diamond-shaped patterns, wherein each diamond-shaped pattern is associated with a radius at a particular section of the fillet and comprises a pair of top-surface triangles that share an edge and a pair of side surface triangles that share an edge, wherein the parametric model facilitates mapping a first draping direction in a first top-surface triangle to a first side surface triangle along a first geodesic and a second draping direction in a second top surface triangle to a second side surface triangle along a second geodesic; and
adjusting, by the computing system, radii associated with one or more of the plurality of connected diamond-shaped patterns to reduce an average angle deviation between the first geodesic and the second geodesic in the pair of side surface triangles across all diamond-shaped patterns to a minimum amount.

3. The method according to claim 2, wherein generating the parametric model that specifies the fillet in terms of the plurality of connected diamond-shaped patterns comprises:
overlapping adjacent diamond-shaped patterns to define a non-manifold model of the fillet.

4. The method according to claim 2, wherein generating the parametric model that specifies the fillet in terms of the plurality of connected diamond-shaped patterns comprises:
generating a parametric model of the fillet that specifies the fillet in terms of a plurality of circle-arc cross-sections, wherein each circle-arc cross-section is specified by points along a circle-arc having a particular radius, wherein points of three adjacent circle-arc cross-sections together with a top point on the top surface and a bottom point on the side surface that are aligned with a middle circle-arc cross-section define a diamond-shaped pattern.

5. The method according to claim 4, wherein adjusting, by the computing system, radii associated with one or more of the plurality of connected diamond-shaped patterns comprises:
determining, for each circle-arc cross-section, a radius r that minimizes an objective function defined as:
$$F ( r ) = {\sum }_{i} {( {v}_{f 1}^{i} ( r ) \cdot {R}_{i} {{v}_{f 2}^{i} ( r )}^{⊥} )}^{2}$$
wherein v_{f1}ⁱ corresponds to a direction of the first geodesic in the first side surface triangle, v_{f2}ⁱ corresponds to a direction of the second geodesic in the second side surface triangle and Rᵢ is a rotation that brings the second side surface triangle into the same plane as the first side surface triangle.

6. The method according to claim 4, wherein adjusting, by the computing system, radii associated with one or more of the plurality of connected diamond-shaped patterns comprises:
determining, for each circle-arc cross-section, a radius r that minimizes an objective function defined as:
$${F}_{θ} ( r ) = {\sum }_{i} {( ∠ {f}_{2 N}^{i} {v}_{f 1} ( r ) - ∠ {f}_{2 N}^{i} {v}_{f 2} ( r ) )}^{2}$$
wherein v_{f1}ⁱ corresponds to a direction of the first geodesic in the first side surface triangle, v_{f2}ⁱ corresponds to a direction of the second geodesic in the second side surface triangle, and f_{N} corresponds a vector that represents the edge between the pair of side surface triangles.

7. The method according to claim 2, wherein adjusting, by the computing system, radii associated with one or more of the plurality of connected diamond-shaped patterns comprises:
maintaining the radii within a predetermined upper limit and a predetermined lower limit.

8. A computing system that facilitates formation of an object from a material, the computing system comprising:
a memory that stores instruction code; and
a processor in communication with the memory, wherein the instruction code is executable by the processor to cause the computing system to perform operations comprising:
receiving, by the computing system, an object model associated with the object, wherein the object model specifies at least a top surface and a side surface connected to an edge of the top surface via a fillet that extends along the edge, and wherein at a particular region along the edge, adjacent planar regions of the side surface define an obtuse angle therebetween;
adjusting, within a parametric model associated with the object model, the fillet along the edge to have a first radius at a particular distance from the particular region and to have a second radius, which is smaller than the first radius, proximate the particular region along the edge; and
communicating, by the computing system, output data associated with an adjusted parametric model to equipment configured to form a mandrel that facilitates formation of the object, wherein adjusting the fillet to have a smaller radius proximate the particular region along the edge facilitates elimination of wrinkles in the material when draped over the mandrel to form the object.

9. The computing system according to claim 8, wherein adjusting the radius of the fillet comprises:
generating a parametric model that specifies the fillet in terms of a plurality of connected diamond-shaped patterns, wherein each diamond-shaped pattern is associated with a radius at a particular section of the fillet and comprises a pair of top-surface triangles that share an edge and a pair of side surface triangles that share an edge, wherein the parametric model facilitates mapping a first draping direction in a first top-surface triangle to a first side surface triangle along a first geodesic and a second draping direction in a second top surface triangle to a second side surface triangle along a second geodesic; and
adjusting, by the computing system, radii associated with one or more of the plurality of connected diamond-shaped patterns to reduce an average angle deviation between the first geodesic and the second geodesic in the pair of side surface triangles across all diamond-shaped patterns to a minimum amount.

10. The computing system according to claim 9, wherein generating the parametric model that specifies the fillet in terms of the plurality of connected diamond-shaped patterns comprises:
overlapping adjacent diamond-shaped patterns to define a non-manifold model of the fillet.

11. The computing system according to claim 9, wherein generating the parametric model that specifies the fillet in terms of the plurality of connected diamond-shaped patterns comprises:
generating a parametric model of the fillet that specifies the fillet in terms of a plurality of circle-arc cross-sections, wherein each circle-arc cross-section is specified by points along a circle-arc having a particular radius, wherein points of three adjacent circle-arc cross-sections together with a top point on the top surface and a bottom point on the side surface that are aligned with a middle circle-arc cross-section define a diamond-shaped pattern.

12. The computing system according to claim 11, wherein adjusting, by the computing system, radii associated with one or more of the plurality of connected diamond-shaped patterns comprises:
determining, for each circle-arc cross-section, a radius r that minimizes an objective function defined as:
$$F ( r ) = {\sum }_{i} {( {v}_{f 1}^{i} ( r ) \cdot {R}_{i} {{v}_{f 2}^{i} ( r )}^{⊥} )}^{2}$$
wherein v_{f1}ⁱ corresponds to a direction of the first geodesic in the first side surface triangle, v_{f2}ⁱ corresponds to a direction of the second geodesic in the second side surface triangle and Rᵢ is a rotation that brings the second side surface triangle into the same plane as the first side surface triangle.

13. The computing system according to claim 11, wherein adjusting, by the computing system, radii associated with one or more of the plurality of connected diamond-shaped patterns comprises:
determining, for each circle-arc cross-section, a radius r that minimizes an objective function defined as:
$${F}_{θ} ( r ) = {\sum }_{i} {( ∠ {f}_{2 N}^{i} {v}_{f 1} ( r ) - ∠ {f}_{2 N}^{i} {v}_{f 2} ( r ) )}^{2}$$
wherein v_{f1}ⁱ corresponds to a direction of the first geodesic in the first side surface triangle, v_{f2}ⁱ corresponds to a direction of the second geodesic in the second side surface triangle, and f_{N} corresponds a vector that represents the edge between the pair of side surface triangles.

14. The computing system according to claim 9, wherein adjusting, by the computing system, radii associated with one or more of the plurality of connected diamond-shaped patterns comprises:
maintaining the radii within a predetermined upper limit and a predetermined lower limit.

15. A method implemented by a computing system that facilitates formation of an object from a material, the method comprising:
receiving, by the computing system, an object model associated with the object, wherein the object model specifies at least a top surface and a side surface connected to an edge of the top surface via a fillet that extends along the edge, and wherein at a particular region along the edge, adjacent planar regions of the side surface define an obtuse angle therebetween;
generating a parametric model that specifies the fillet in terms of a plurality of connected diamond-shaped patterns, wherein each diamond-shaped pattern is associated with a radius at a particular section of the fillet and comprises a pair of top-surface triangles that share an edge and a pair of side surface triangles that share an edge, wherein the parametric model facilitates mapping a first draping direction in a first top-surface triangle to a first side surface triangle along a first geodesic and a second draping direction in a second top surface triangle to a second side surface triangle along a second geodesic;
adjusting, by the computing system, radii associated with one or more of the plurality of connected diamond-shaped patterns to reduce an average angle deviation between the first geodesic and the second geodesic in the pair of side surface triangles across all diamond-shaped patterns to a minimum amount; and
communicating, by the computing system, output data associated with an adjusted parametric model to equipment configured to form a mandrel that facilitates formation of the object, wherein adjusting the radii associated with one or more of the plurality of connected diamond-shaped patterns facilitates elimination of wrinkles in the material when draped over the mandrel to form the object.

16. The method according to claim 15, wherein generating the parametric model that specifies the fillet in terms of the plurality of connected diamond-shaped patterns comprises:
overlapping adjacent diamond-shaped patterns to define a non-manifold model of the fillet.

17. The method according to claim 15, wherein generating the parametric model that specifies the fillet in terms of the plurality of connected diamond-shaped patterns comprises:
generating a parametric model of the fillet that specifies the fillet in terms of a plurality of circle-arc cross-sections, wherein each circle-arc cross-section is specified by points along a circle-arc having a particular radius, wherein points of three adjacent circle-arc cross-sections together with a top point on the top surface and a bottom point on the side surface that are aligned with a middle circle-arc cross-section define a diamond-shaped pattern.

18. The method according to claim 17, wherein adjusting, by the computing system, radii associated with one or more of the plurality of connected diamond-shaped patterns comprises:
determining, for each circle-arc cross-section, a radius r that minimizes an objective function defined as:
$$F ( r ) = {\sum }_{i} {( {v}_{f 1}^{i} ( r ) \cdot {R}_{i} {{v}_{f 2}^{i} ( r )}^{⊥} )}^{2}$$
wherein v_{f1}ⁱ corresponds to a direction of the first geodesic in the first side surface triangle, v_{f2}ⁱ corresponds to a direction of the second geodesic in the second side surface triangle and Rᵢ is a rotation that brings the second side surface triangle into the same plane as the first side surface triangle.

19. The method according to claim 17, wherein adjusting, by the computing system, radii associated with one or more of the plurality of connected diamond-shaped patterns comprises:
determining, for each circle-arc cross-section, a radius r that minimizes an objective function defined as:
$${F}_{θ} ( r ) = {\sum }_{i} {( ∠ {f}_{2 N}^{i} {v}_{f 1} ( r ) - ∠ {f}_{2 N}^{i} {v}_{f 2} ( r ) )}^{2}$$
wherein v_{f1}ⁱ corresponds to a direction of the first geodesic in the first side surface triangle, v_{f2}ⁱ corresponds to a direction of the second geodesic in the second side surface triangle, and f_{N} corresponds a vector that represents the edge between the pair of side surface triangles.

20. The method according to claim 15, wherein adjusting, by the computing system, radii associated with one or more of the plurality of connected diamond-shaped patterns comprises:
maintaining the radii within a predetermined upper limit and a predetermined lower limit.
